(19) United States
(12) Patent Application Publication
(10) Pub. No.: US 2005/0058762 A1
(43) Pub. Date: Mar. 17, 2005

(54) Custard caramel sauce

(75) Inventor: David L. Kroening, New Ulm, MN (US)

Correspondence Address: INTELLECTUAL PROPERTY GROUP;FREDRIKSON & BYRON, P.A., 200 SOUTH SIXTH STREET, SUITE 4000, MINNEAPOLIS, MN, 55402, US

(73) Assignee: Michael Foods, Inc., Minnetonka, MN (US)

(21) Appl. No.: 10/664,115

(22) Filed: Sep. 17, 2003

(51) Int. Cl. A23L 1/238

(52) U.S. Cl. 426/589

(57) ABSTRACT

A custard caramel sauce formed of a pasteurized oil and water emulsion in which the oil can include butter and in which the water includes sugar dissolved in the water, and in which an enzyme-modified yolk (EMY) is present as an emulsifier. The present invention provides caramel and caramel sauces having an egg or custard-type flavor. Egg yolk is used as an emulsifier, at least partially in place of the cream conventional used to make caramels. The use of egg yolk is made possible by using enzyme-modified yolk in place of unprocessed egg yolk. As the mixture is heated, the proteins are able to thicken the sauce, but the EMY is able to keep the sauce from breaking into fat/oil and aqueous phases. The enzyme-modified yolk also enables providing a liquid custard caramel sauce that can be sold in a cooled refrigerated package and subsequently reheated without the unappealing coagulation of the egg yolk proteins and subsequent phase separation in the sauce after heating. The custard caramel sauce can be made by adding melted butter to enzyme-modified egg yolk, sugar, and water to form an emulsion. The emulsion can be homogenized and then heated to form a gel. The gel can be liquefied through high shear or cooling to form the custard caramel sauce.

### RELATED APPLICATIONS

The present application is related to U.S. patent application Ser. No. 10/386,966, filed Mar. 11, 2003, titled FORMULATED HOLLANDAISE SAUCE AND PROCESS FOR PREPARATION OF THE SAME.

### FIELD OF THE INVENTION

The present application is related generally to food processing. More specifically, the present application is related to a process for making a caramel sauce using egg products.

### BACKGROUND OF THE INVENTION

Caramel sauces and caramels are well known. Caramel sauce can be made by mixing sugar and water together. The sugar and water is heated to a relatively high temperature and cream is added to the hot sugar and water mixture. The cream performs two functions. Firstly, the relatively cool cream lowers the temperature of the sugar solution. Secondly, the cool cream interferes with the crystallization of the sugar solution, interfering with the formation of large sugar crystals. Caramel sauce preferably does not include large sugar crystals, avoiding the “sugary” mouth feel.

Caramel sauces can be flowable, even when cold. Such caramel sauces can be poured over ice cream or fruit. Caramel sauces may be more viscous, for example, being flowable only when heated. Caramels can be still more viscous, forming soft, easily chewable candies. Even more viscous caramel can form very hard, difficult to chew caramels, which dissolve over time in the mouth. The degree of hardness can be imparted by heating the sugar solution to a higher temperature, and by controlling the amount of cream that is added to the sugar solution. The brown color is dependent upon heating the sugar solution to a sufficiently high temperature to caramelize the sugar. Caramels can have other flavors imparted by adding flavoring during the processing.

Egg yolks are commonly used in food products as an emulsifier. While the use of egg yolks in cooking, baking, and other food processing is well known, the applicant is unaware of egg yolks being used as an emulsifier in caramel or being used to add an egg or custard-type flavor to caramel.

The applicant believes that the current lack of egg flavored caramel exists for good reason. The use of egg yolk in forming caramel would cause substantial difficulties that have not previously been overcome. Firstly, if egg yolk is used in place of cream in caramel manufacture, the results are less than desirable. Adding a cool egg yolk to a hot sugar solution may cool the sugar solution, but would also cook the egg yolk, resulting in a “scrambled egg” component in the cooled sugar solution, an undesirable result. Secondly, if the egg yolk were added to the sugar and water prior to the heating step, the egg yolk proteins would coagulate on heating, also producing an undesirable end result. Thirdly, egg yolks, while being extremely nutritious, can carry pathogens. For this reason, raw eggs are not normally included in food products sold and intended for direct consumption. In particular, egg yolks are typically cooked prior to being consumed or have the bacterial count significantly reduced in other ways. This cooking would result in a safe but undesirable-tasting food product. Finally, even if egg yolk was somehow used to make a caramel sauce, if the caramel sauce were heated, for example after being sold in a refrigerated package, the egg protein would curdle, causing the emulsion to break and the sauce to separate into two phases.

What would be unique and desirable is caramel made using egg yolk. What would be advantageous are pasteurized caramels or caramel sauces made using egg yolk at least partially in place of cream. What would be most advantageous are refrigerated caramel sauces having an egg flavor, where the caramel sauces can be heated by the end user without the egg yolk proteins coagulating and separating out from the sauce rather than continuing to function as an emulsifying agent.

### SUMMARY OF THE INVENTION

The present invention provides caramels and caramel sauces having an egg or custard type flavor. The custard caramel utilizes enzyme modified egg yolk as a source of protein and fat, in place of cream that is traditionally used to make caramel. The caramel is preferably cooked, a process that would normally denature unprocessed egg yolk, causing coagulation of egg protein, loss of the emulsifying properties, and subsequent phase separation in caramel sauces.

The resulting custard caramel sauce is a flowable, pourable sauce having the flavor compounds of caramel (dairy notes from butter, and sugar cooked to high temperatures) and custard (from the yolk). The yolk provides a new flavor compound, creates an emulsion, and also forms a gel on heating that is destroyed with further processing. The processing yields a smooth, reheatable product having caramel and custard flavors.

The present invention provides a custard caramel sauce including enzyme-modified egg yolk, sugar, liquid fat, and water. The liquid fat and water form an emulsion. The custard caramel sauce thus provided can also be pasteurized. The enzyme-modified yolk can comprise between about 5 and 9 weight percent of the sauce, preferably between about 6 and 8 weight percent of the sauce. The liquid fat is preferably a butter blend selected from the group consisting of butter, margarine, and combinations thereof. Some sauces have essentially pure butter as the liquid fat source. The butter blend can form between about 38 and 58 weight percent of the sauce in some embodiments and between about 43 and 52 weight percent of the sauce in other embodiments. Sugar can form between about 29 and 43 weight percent of the sauce in some sauces and between about 33 and 39 weight percent in other sauces. The sauce is preferably cooled to a temperature of less than 100° F., either before or after being packaged. The sauce is then allowed to cool to less than 40° F.

The present invention thus provides a custard caramel sauce including a pasteurized oil-in-water emulsion, in which the oil may include butter and in which the water includes a sugar dissolved in the water, and in which an enzyme-modified yolk is present as an emulsifier.

The present invention provides a process for making a custard caramel sauce including melting a fat source to form a liquid fat. In some processes, the fat source is a butter blend selected from the group consisting of butter, margarine, and combinations thereof. In one process, the butter blend consists essentially of butter.

Enzyme-modified egg yolk, sugar, and water can be mixed together concurrently with the fat or butter blend melting. The liquid fat source can be combined with the enzyme-modified egg yolk, sugar and water mixture to form an emulsion. The emulsion can then be homogenized and heated to form a gel. Destroying the gel by liquefying then forms the liquid custard caramel sauce. Enzyme modified yolk can thus be used to replace the cream typically used in caramel production, in whole or in part. The enzyme modified yolk provides an emulsifier that can be pasteurized, sold in refrigerated form, and later reheated by the end user, all without curdling, coagulation, or phase separation that would occur if unprocessed egg yolks were used.

In some processes incorporating the present invention, the homogenizing is performed prior to the heating, while in other processes, preheating is performed prior to the homogenizing. The liquefying may include passing the gel through a shear pump. The liquefying can also be accomplished by cooling the gel, for example, by passing the gel through a heat exchanger. In some processes, the heating includes heating the emulsion in a first pre-heating step to a first temperature, followed by heating the emulsion in a second heating step to a second temperature, where the second temperature is higher than the first temperature. This preheating step can reduce subjecting the emulsion to a very high heat exchanger surface temperature and can provide for a more controlled final temperature. The heating can be used to both pasteurize the emulsion and to form a gel.

Combining the enzyme-modified egg yolk, sugar, water, and liquid fat to form the emulsion can be accomplished by subjecting the mixture to a shear sufficiently high to form the emulsion. Such shear can be provided by passing the liquid fat, enzyme-modified egg yolk, sugar, and water through a shear pump. In some processes, the enzyme-modified egg yolk, sugar, and water are mixed in a first vessel, and the melted fat is added to the first vessel after the mixing. Various flavors, for example, caramel and vanilla flavoring can be added to the starting ingredients in some processes.

The enzyme-modified egg yolk can form between about 5% and 10% of the total ingredient weight in some embodiments, and about 7% of the total ingredient weight in one particular embodiment. The liquid fat or butter blend can form between about 40% and 60% of the total ingredient weight in one embodiment, and between about 45% and 54% of the total ingredient weight in another embodiment. The sugar can form between about 30% and 50% of the total ingredient weight in one embodiment, and between about 32% and about 40% of the total ingredient weight in another embodiment.

In one method for making a custard caramel sauce, a butter blend is melted, where the butter blend is selected from the group consisting of butter, margarine and combinations thereof. Some butter blends consist essentially of butter. Enzyme-modified egg yolk, sugar, and water can be mixed together, followed by combining the mixture with the melted butter blend to form an emulsion. The emulsion can be formed by whipping the mixture while adding the melted butter blend or by passing the mixture and butter blend through a pump, for example, a shear pump. The emulsion thus formed can be heated to form a gel. The emulsion may then be homogenized and cooled. Cooling the sauce can liquefy the gel to form a liquid custard caramel sauce. The heating may be greater than about 170° F. in one embodiment, and may be between about 165° F. and 185° F. for more than 15 seconds in another embodiment. The heating preferably includes heating the homogenized emulsion to a temperature of about 175° F. for at least half a minute. The heating can include a pre-heating step, followed by a heating step to the final temperature.

The cooling can include passing the gel through a swept film or wiped surface heat exchanger. The homogenizing can include passing the gel through a shear pump, or by passing the gel through an orifice under high pressure. The liquefied custard caramel sauce, which may be cooled, can be packaged using a packaging machine.

In another method according to the present invention, a butter blend selected from the group consisting of butter, margarine and combinations thereof is melted. The melted butter blend can be mixed together with enzyme-modified egg yolk, sugar, and water to form an emulsion and the emulsion homogenized. The homogenized emulsion can then be heated to form a gel, and the gel subjected to a high shear to liquefy the gel to form the liquid custard caramel sauce. The heating can include heating the homogenized emulsion to a temperature between about 165° F. and about 185° F. for more than 15 seconds. The heating preferably includes heating the homogenized emulsion to a temperature of about 175° F. for at least about half a minute.

### DESCRIPTION OF THE DRAWINGS

FIG. 1 is a schematic diagram of a process for making a custard caramel sauce including adding a melted butter mixture to a mixture of sugar, enzyme modified egg yolk, and water to form an emulsion, homogenizing the mixture/emulsion followed by heating the emulsion to form a gel, transferring the gel using a shear pump, followed by cooling the gel to liquefy the gel to a sauce, and warm filling the sauce; and

FIG. 2 is a schematic diagram of another process for making a custard caramel sauce including adding a melted butter mixture to a mixture of sugar, enzyme modified egg yolk, and water to form an emulsion, homogenizing the emulsion, pre-heating and heating the emulsion to form a gel, followed by liquefying the gel to a sauce using a shear pump and/or swept surfaces followed by hot filling the sauce.

### DETAILED DESCRIPTION OF THE PREFERRED EMBODIMENTS

The present invention utilizes enzyme-modified yolk “EMY” to form egg or custard-flavored caramel products. Enzyme-modified yolks are well known, commercially available products. Processes for making enzyme-modified yolks are described in U.S. Pat. Nos. 5,213,968 and 4,034,124, herein incorporated by reference in their entireties. Enzyme-modified yolks are commercially available through sources such as Michael Foods, Inc. (Minnetonka, Minn.).

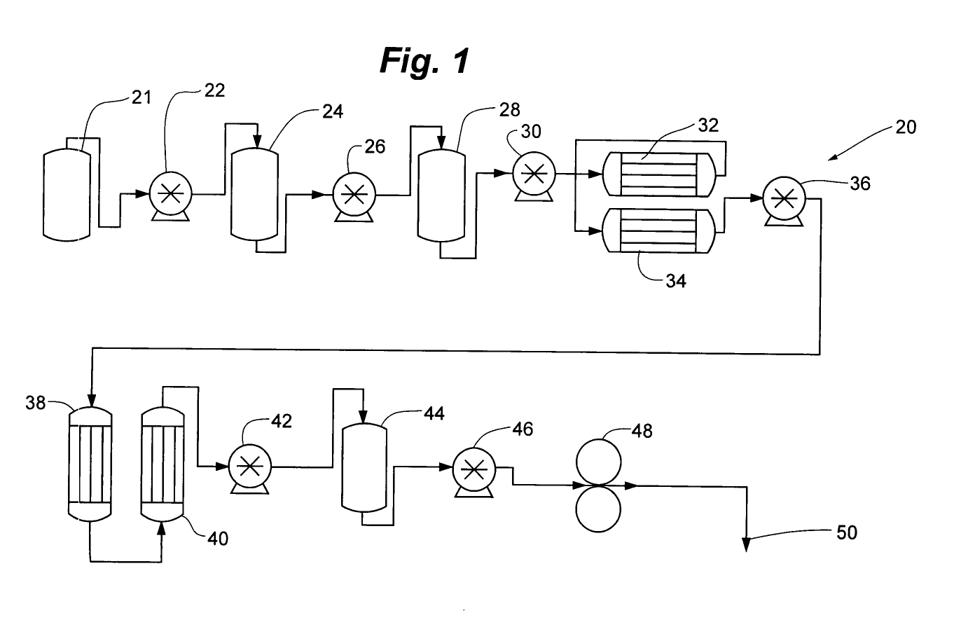

Referring now to FIG. 1, a process 20 for making custard caramel sauce is illustrated. A vessel 21 is provided for containing a liquid fat product used in the present process. The liquid fat product preferably includes a butter blend, which can contain butter, margarine, and combinations thereof. Vessel 21 is preferably a jacketed, heated vessel for melting the butter or butter-blend liquid fat source. In one process, butter is melted to approximately 125° F. or 51.7° C., while keeping the melted butter continuously agitated so that any butter solids remain in suspension.

Enzyme-modified egg yolk, sugar, water, and any flavors can be added to a second vessel 24. The ingredients can be combined and mixed, using an agitator, an in-line mixer, a recirculating pump, or other mixing devices well known to those skilled in the art. In some processes, the enzyme-modified egg yolk is added to the mixed and previously dissolved sugar and water solution. The enzyme-modified egg yolk/water/sugar solution may be preheated or may remain cool prior to combination with the melted butter or margarine. Generally, the EMY retort stable egg yolk is maintained at a temperature of 47° F. or 8.3° C. The EMY egg yolk/water/sugar solution is also preferable kept in continuous motion to prevent settling and separation of the individual ingredients. The EMY retort stable egg yolk may be placed into a “Breddo-Liquifier” where the dissolved solution of sugar and water may be exposed to the continuous agitation. Generally, the EMY retort stable egg yolk, sugar, water, and any flavoring is mixed cold and has not been preheated prior to mixing with the melted butter ingredients. The EMY retort stable egg yolk may be salted, in which case the butter and/or margarine as melted is unsalted. Alternatively, in the event that the EMY retort stable egg yolk is not salted, then the butter and/or margarine may be salted within the formulation of the custard caramel sauce.

The melted butter blend may be transferred via pump 22 to vessel 24 containing the enzyme-modified yolk, water, and sugar, under agitation or mixing to form an emulsion. Generally, the temperature of the now-mixed and emulsified sauce formed of the melted butter, enzyme-modified egg yolk, water, and sugar is held at approximately 105° F. or 40.5° C. The pH, water activity, viscosity, and flavor of the formulated custard caramel sauce may then be tested. Generally, the custard caramel sauce is maintained in continuous motion to prevent break down of the formed emulsion. An Eisher mixer may be used to combine and mix the melted butter to the enzyme modified egg yolk/water/sugar solution.

A pump 26, which can be a shear pump, can then be used to transfer the custard caramel sauce emulsion to a holding vessel 28. The emulsion from vessel 28 can then be transferred via pump 30 to heat exchangers 32 and 34. Pump 30 can be a shear pump, including as a component the smallest screen available for filtration and breakage of clumps within the custard caramel sauce. The heating can occur, in some processes, in a first preheat step followed by a second heating or pasteurization step. In one embodiment, the emulsion is first pumped through a first heat exchanger 32 that raises the temperature of the emulsion between about 140° and 145° F. The emulsion can then be sent to second heat exchanger 34 which can heat the emulsion to a pasteurization temperature of about 175° F. for about 30 seconds. This heating both pasteurizes the emulsion and forms a protein gel. Applicant believes that the enzyme modified egg yolk thus forms a protein gel with lipids, “a gel” where the proteins and the lipids remain together in an emulsified macromolecular state.

The gel can then be transferred via a pump 36 to chillers 38 and 40. The gel needs a finishing step to break the gel into tiny fragments to become, or return to, a liquefied and pourable state. Pump 36 is preferably a shear pump which subjects the gel to a sufficiently high shear to break the gel and liquefy the custard caramel sauce product to reform the emulsion. The shear pump thus acts as the homogenizer and homogenizes the custard caramel product after the heating step.

The custard caramel liquid can then be fed to a first chiller 38 and a second chiller 40. Chillers 38 and 40 can be swept film or wiped surface heat exchangers, able to handle the viscous liquid. In some processes, pump 36 subjects the custard caramel gel to some shear, but the swept film chillers 38 and 40 perform most of the liquefaction function. In one process, the chillers cool the liquid to a temperature of about 110° F. or 43.3° C. The cooling and swept film actions can act to liquefy a gel being fed to the chillers. The cooled, liquefied custard caramel sauce can then be transferred through pump 42 to a holding vessel 44. Pump 42 can, once again, be a shear pump in some embodiments. Another pump, pump 46, can be used to transfer the contents of holding vessel 44 to a filling machine 48. Filing machine can be used to cold fill individual packages with the liquid, cooled, custard caramel sauce. The packaged custard caramel sauce can then be sent to a freezer 50.

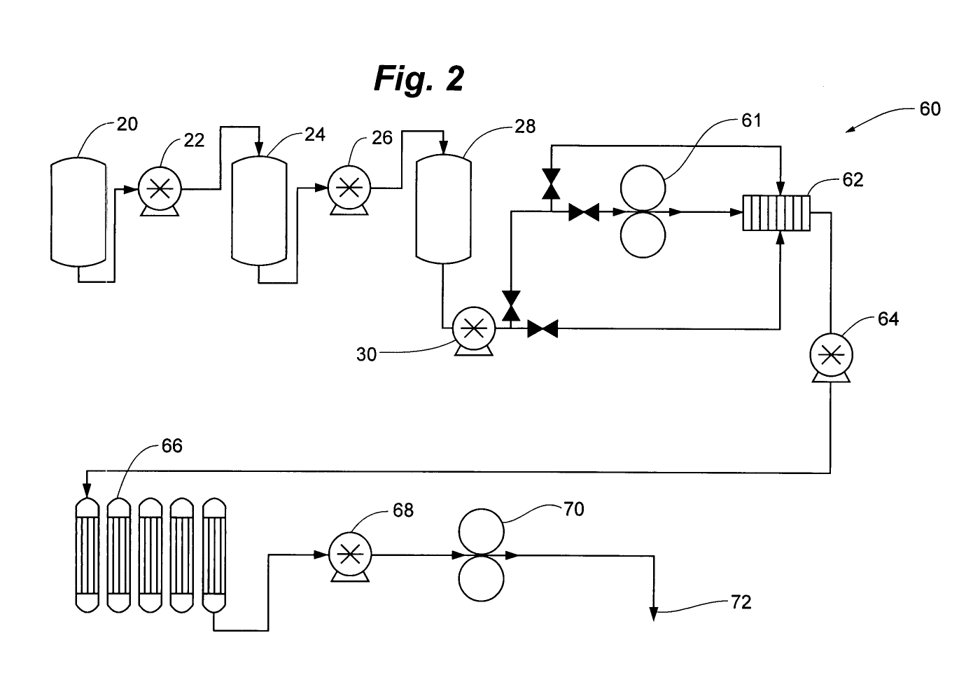

FIG. 2 illustrates another process 60 for making custard caramel sauce according to the present invention. Liquid fat, preferably butter, can be added to vessel 20 and transferred using pump 22, as previously described with respect to FIG. 1. Similarly, enzyme modified yolk, water, sugar, and any flavors, can be added to vessel 24 as previously discussed. Melted butter can be added to vessel 24 under mixing or agitation to produce the custard caramel sauce emulsion. The emulsion can then be transferred through pump 26 to holding vessel 28, as previously described and then transferred further through pump 30.

In process 60, a homogenizer 61 is used to first homogenize the custard caramel sauce emulsion. Homogenizers are well known to those skilled in the art. The homogenization may be provided in two stages, where the first stage exposes the custard caramel sauce emulsion to 500 psi, and the second stage exposes the emulsion to 1000 psi. The emulsion can be homogenized for approximately 30 seconds, ±5 seconds, in some embodiments. The homogenized emulsion can then be transferred to a plate heat exchanger 62 for preheating the emulsion. Plate heat exchanger 62 raises the temperature of the homogenized emulsion to between about 140° and 145° F. in some embodiments. Preheating the emulsion can avoid the “shock” of subjecting the emulsion to an extremely hot heat exchanger surface temperature and also allows for a tighter control of the final emulsion temperature after the heating step. The preheated emulsion can be transferred through a pump 64, which can be a shear pump, to a tube-in-tube heat exchanger 66. The tube-in-tube heat exchanger 66 can perform the final heating step, and can heat the emulsion to a temperature of about 175° F. for about 30 seconds, in some methods. The heating and tube-in-tube heat exchanger 66 can perform two functions. First, the heating can pasteurize the egg containing product. Second, the heating forms a protein gel from the emulsion. The gel can be transferred through a pump, for example, a shear pump 68. Pump 68 can act to break the gel forming a liquefied custard caramel sauce. The temperature exiting pump 68 can be about 105° F. or about 40.6° C., in some embodiments. The warm custard caramel sauce can then be hot filled using a filling machine 70. Filling machine 70 can fill individual packages with the custard caramel sauce, with the packages going to a freezer 72.

As previously discussed, the emulsion can be first preheated then homogenized, or first homogenized, then preheated. The homogenization can be accomplished with either a conventional homogenizer or a shear pump, or both. The liquefaction can be accomplished with a swept film heat exchanger, a shear pump, or both. The liquefied, custard caramel sauce emulsion may then be either hot filled or cold filled into individual packages.

TABLE 1
(Colored Version)

| Ingredient | Wt % | Amount (lbs.) |
|---|---|---|
| Enzyme Modified Yolk Pasteurized | 7.18 | 5.39 |
| Water | 7.18 | 5.39 |
| Citric Acid | 0.06 | 0.05 |
| Butter Blend | 48.64 | 36.48 |
| Sugar | 36.08 | 27.06 |
| Vanilla | 0.20 | 0.15 |
| HT-W Kalsec | 0.05 | 0.04 |
| Caramel Color | 0.60 | 0.45 |
| | 100% | 75 |

TABLE 2
(Uncolored Version)

| Ingredient | Wt % | Amount (lbs.) |
|---|---|---|
| Enzyme Modified Yolk | 7.18 | 5.39 |
| Water | 7.18 | 5.39 |
| Citric Acid | 0.06 | 0.05 |
| Butter Blend | 48.64 | 36.48 |
| Sugar | 36.08 | 27.06 |
| Vanilla | 0.20 | 0.15 |
| HT-W Kalsec | 0.05 | 0.04 |
| | 100% | 75 |

### EXAMPLE 1

The ingredients in example 1 are as detailed in Table 1 above. 36.48 lbs. of butter blend were added, which in this example was 60 percent margarine and 40 percent butter including as ingredients sweet cream, liquid corn oil, partially hydrogenated corn oil, sweet cream buttermilk, water, salt, mono-diglycerides, artificial flavor, natural annatto coloring, and vitamin A Palmitate. The butter blend was melted in a first vessel. 27.06 lbs. of sugar, 5.39 lbs. of Enzyme Modified Yolk (EMY) (salted, unkosher enzyme modified yolk), 5.39 lbs. water, 0.05 lbs. citric acid, 0.15 lbs. vanilla, 0.45 lbs. Sethness 212 caramel color (available from Sethness Corp. Clinton, Iowa) and 0.04 lbs. HT-W Kalsec (an anti-oxidant) were added to a second vessel and agitated. The butter blend was heated to a temperature of about 125° F. or 51.7° C., and added to the egg yolk mixture vessel. The melted butter blend was added slowly, to form a custard caramel sauce emulsion.

The process as illustrated in FIG. 2 and as described with respect to FIG. 2 was used to make the custard caramel sauce of Example 1. Four separate batches were made in this way. The custard caramel sauce product made in Example 1 was smooth and flowable. The product had a deep dark brown color and had an appearance of “pancake syrup”, yet was thicker. The flavor was sweet and buttery, with an identified flavor of custard. Applicant believes this custard flavor came from the egg yolk. The overall flavor was complex to the point where is had sweetness and an eggy flavor.

The product was reheated using a microwave. The product foamed up when hot, and reduced in volume when stirred. Once hot, the sauce thinned a great deal making pouring a snap. As this product cooled, it hesitated to drip and slide over the carrier (e.g. sweet quick breads, fruits, ice creams, etc).

The water activity (A_{w}) of Example 1 was measured, having a value of 0.876. The pH of Example 1 was 4.65, and the percent solids were 69.06%. Applicant believes that a variant of Example 1, having other parameters the same, but having the water decreased to about 4.5 weight percent and the sugar increased to about 40 weight percent would have a water activity of less than about 0.85 and a pH of less than about 4.60, making the custard caramel sauce shelf stable.

### EXAMPLE 2

The recipe of Table 2 was used together with the process described with respect to FIG. 2, to make one batch of custard caramel sauce. The recipe of Example 2 was the same as that of Example 1, but without any caramel color added. The product of Example 2 had a peculiar color, as it was intensely yellow. The product had a truly artificial margarine type color. This product tasted quite differently than the product with coloring. The sample did not have the “burnt or brown” flavor often associated with caramel colors. Reheating the product caused the same result stated earlier. The product foamed up, and once stirred, came back to a non-foamy type of sauce.

One embodiment of the present invention includes ice cream having a revel or ribbon of the custard caramel sauce present in the ice cream. The ribbon of custard caramel can provide a unique flavor and texture, as the Applicant believes the custard caramel sauce should not freeze at normal ice cream storage temperatures. Another embodiment of the invention includes custard caramel sauce used as a syrup to top pancakes, French toast, fruit, or ice cream. Still another embodiment of the invention includes chocolate covered or enrobed custard caramel, for example a nougat layer topped by a custard caramel layer (which can include peanuts), with both layers covered in chocolate. Yet another example of the invention includes French toast or French toast sticks having a custard caramel sauce applied to the French toast. The French toast can be frozen, with the custard caramel sauce coating or forming a layer over at least one surface, where the frozen French toast can later be microwaved.

The detailed description above should be read with reference to the drawings, in which like elements in different drawings are numbered identically. The drawings, which are not necessarily to scale, depict selected embodiments and are not intended to limit the scope of the invention. Several forms of invention have been shown and described, and other forms will now be apparent to those skilled in art. It will be understood that embodiments shown in drawings and described above are merely for illustrative purposes, and are not intended to limit the scope of the invention as defined in the claims that follow.

1. A process for making a custard caramel sauce, the process comprising:
providing a liquid fat;
mixing together enzyme modified egg yolk, sugar, and water;
combining the mixed enzyme modified egg yolk, sugar, water, and liquid fat to form an emulsion;
homogenizing the emulsion;
heating the emulsion to form a gel; and
liquefying the gel to form the custard caramel sauce.

2. A process as in claim 1, in which the homogenizing is performed prior to the heating.

3. A process as in claim 1, in which the heating is performed prior to the homogenizing.

4. A process as in claim 1, in which the liquefying includes passing the gel through a shear pump.

5. A process as in claim 1, in which the liquefying includes cooling the gel.

6. A process as in claim 1, in which the heating includes a first heating step for heating the emulsion to a first temperature and a second heating step for heating the emulsion to a second temperature that is higher than the first temperature.

7. The process as in claim 1, in which providing a liquid fat includes melting a butter blend selected from the group consisting of butter, margarine, and combinations thereof.

8. The process as in claim 7, in which the melting butter-blend melts butter blend consisting essentially of butter.

9. The process as in claim 1, in which the combining to form an emulsion includes subjecting the liquid fat enzyme modified egg yolk, sugar, and water to shear sufficiently high to form the emulsion.

10. The process as in claim 1, in which the homogenizing includes passing the liquid fat, enzyme modified egg yolk, sugar, and water through a shear pump.

11. The process as in claim 1, in which the enzyme modified egg yolk, sugar, and water is mixed in a first vessel, and in which the liquid fat is added to the first vessel.

12. The process as in claim 11, in which the liquid fat is melted in a second vessel.

13. The process as in claim 1, in which the heating includes pasteurizing the homogenized emulsion.

14. The process as in claim 1, further comprising adding at least one flavor to the enzyme modified egg yolk, sugar, water, or liquid fat.

15. The process as in claim 1, further comprising adding caramel flavor to the enzyme modified egg yolk, sugar, water, or liquid fat.

16. The process as in claim 1, further comprising adding vanilla flavor to the enzyme modified egg yolk, sugar, water, or liquid fat.

17. The process as in claim 1, in which the enzyme modified yolk comprises between about 5 percent and about 10 percent of the total ingredient weight.

18. The process as in claim 1, in which the liquid fat comprises between about 40 percent and 60 percent of the total ingredient weight.

19. The process as in claim 1, in which the liquid fat comprises between about 45 percent and 54 percent of the total ingredient weight.

20. The process as in claim 1, in which the sugar comprises between about 30 percent and about 50 percent of the total ingredient weight.

21. The process as in claim 1, in which the sugar comprises between about 32 percent and about 40 percent of the total ingredient weight.

22. A process for making a custard caramel sauce, the process comprising:
melting a butter blend selected from the group consisting of butter, margarine, and combinations thereof;
mixing together enzyme modified egg yolk, sugar, and water;
combining the mixed enzyme modified egg yolk, sugar, water, and melted butter blend to form an emulsion;
heating the emulsion to form a gel;
homogenizing the emulsion; and
cooling the gel to liquefy the gel to form the custard caramel sauce.

23. The process as in claim 22, in which the heating includes heating the homogenized emulsion to a temperature greater than about 170 degrees F.

24. The process as in claim 22, in which the heating includes heating the homogenized emulsion to a temperature between about 165 degrees F. and 185 degrees F. for more than 15 seconds.

25. The process as in claim 22, in which the heating includes heating the homogenized emulsion to a temperature of about 175 degrees F. for at least about half a minute.

26. The process as in claim 22, in which the cooling includes passing the gel through a swept film heat exchanger.

27. The process as in claim 22, in which the homogenizing includes passing the gel through a shear pump.

28. The process as in claim 22, further comprising packaging the cooled liquefied sauce.

29. The process as in claim 28, further comprising transferring the cooled sauce to a depositor prior to the packaging.

30. A process for making a custard caramel sauce, the process comprising:
melting a butter blend selected from the group consisting of butter, margarine, and combinations thereof;
mixing together enzyme modified egg yolk, sugar, and water;
combining the mixed enzyme modified egg yolk, sugar, water, and melted butter blend to form an emulsion;
homogenizing the emulsion;
heating the homogenized emulsion to form a gel; and
subjecting the gel to a shear sufficiently high to liquefy the gel to the custard caramel sauce.

31. The process as in claim 30, in which the heating includes heating the homogenized emulsion to a temperature greater than about 170 degrees F.

32. The process as in claim 30, in which the heating includes heating the homogenized emulsion to a temperature between about 165 degrees F. and 185 degrees F. for more than 15 seconds.

33. The process as in claim 30, in which the heating includes heating the homogenized emulsion to a temperature of about 175 degrees F. for at least about half a minute.

34. The process as in claim 30, in which the subjecting the gel to shear includes passing the gel through a shear pump.

35. The process as in claim 30, further comprising packaging the liquefied sauce.

36. The process as in claim 35, further comprising transferring the sauce to a depositor prior to the packaging.

37. A custard caramel sauce comprising:
enzyme modified egg yolk;
sugar;
liquid fat; and
water,
in which the liquid fat and water form an oil-in-water emulsion, and in which the sauce is pasteurized.

38. A custard caramel sauce as in claim 37, in which the sauce has a pH of less than about 4.6.

39. A custard caramel sauce as in claim 37, in which the sauce has a water activity of less than about 0.85.

40. A custard caramel sauce as in claim 37, in which the sauce has a pH of less than about 4.6, and in which the sauce has a water activity of less than about 0.85.

41. A custard caramel sauce as in claim 37, in which the sauce is shelf stable.

42. A custard caramel sauce as in claim 37, in which the enzyme modified egg yolk comprises between about 5 and 9 weight percent of the sauce.

43. A custard caramel sauce as in claim 37, in which the enzyme modified egg yolk comprises between about 6 and 8 weight percent of the sauce.

44. A custard caramel sauce as in claim 37, in which the liquid fat is a butter blend selected from the group consisting of butter, margarine, and combinations thereof.

45. A custard caramel sauce as in claim 37, in which the liquid fat consists essentially of butter.

46. A custard caramel sauce as in claim 44, in which the butter blend comprises between about 38 and 58 weight percent of the sauce.

47. A custard caramel sauce as in claim 44, in which the butter blend comprises between about 43 and 52 weight percent of the sauce.

48. A custard caramel sauce as in claim 37, in which the sugar comprises between about 29 and 43 weight percent of the sauce.

49. A custard caramel sauce as in claim 37, in which the sugar comprises between about 33 and 39 weight percent of the sauce.

50. A custard caramel sauce as in claim 37, in which the sauce has a temperature of less than 40 degrees F.

51. A custard caramel sauce comprising a pasteurized oil and water emulsion, in which the oil includes a fat and in which the water includes a sugar dissolved in the water, and in which enzyme-modified egg yolk is present as an emulsifier.

52. A custard caramel sauce as in claim 51, in which the fat includes butter.

53. A custard caramel sauce as in claim 51, in which the fat comprises between 38 and 58 weight percent of the sauce.

54. A custard caramel sauce as in claim 51, in which the sugar comprises between 29 and 43 weight percent of the sauce.

55. A custard caramel sauce as in claim 51, in which the enzyme modified egg yolk comprises between 5 and 9 weight percent of the sauce.

56. A custard caramel sauce as in claim 51, in which the enzyme modified egg yolk comprises between 6 and 8 weight percent of the sauce.

57. A custard caramel sauce as in claim 51, in which the sauce has a pH of less than about 4.6.

58. A custard caramel sauce as in claim 51, in which the sauce has a water activity of less than about 0.85.

59. A custard caramel sauce as in claim 51, in which the sauce has a pH of less than about 4.6, and in which the sauce has a water activity of less than about 0.85.
